(19) United States
(12) Patent Application Publication
(10) Pub. No.: US 2020/0110584 A1
(43) Pub. Date: Apr. 9, 2020

(54) AUTOMATED CODE GENERATION FOR FUNCTIONAL TESTING OF SOFTWARE APPLICATIONS

(71) Applicant: Electronic Arts Inc., Redwood City, CA (US)

(72) Inventors: Adrian Irimescu, Burnaby (CA); Dalibor Maric, Burnaby (CA)

(21) Appl. No.: 16/151,813

(22) Filed: Oct. 4, 2018

(51) Int. Cl. G06F 8/30; G06F 11/36; G06F 8/75

(52) U.S. Cl. CPC G06F 8/30; G06F 8/75; G06F 11/3688

(57) ABSTRACT

An example method of automated code generation to facilitate cross-platform software interfaces may comprise: receiving a definition of an application programming interface (API) exposed by a target executable code running on a server; generating a first code implementing a client proxy for translating an incoming API call to a remote procedure invocation request; generating a second code implementing a server dispatcher for receiving the remote procedure invocation request, decoding a method identifier encoded by the remote procedure invocation request, and forwarding the remote procedure invocation request to a server stub identified by the method identifier; and generating a third code implementing the server stub for translating the remote procedure invocation request into a call to the API exposed by the target executable code.

### TECHNICAL FIELD

The present disclosure is generally related to software testing, and is more specifically related to automated code generation for functional testing of software applications.

### BACKGROUND

A software module, such as a static or dynamically loadable library, may expose an application programming interface (API), which may define a set of functions invocable by other software modules. In certain implementations, a static or dynamically loadable library may be a part of a software development kit (SDK) that facilitates development of applications for a certain platform (e.g., defined by a software framework, middleware layer, operating system, and/or hardware platform).

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 schematically illustrates a high-level component diagram of a distributed computer system operating in accordance with one or more aspects of the present disclosure;

FIG. 2 schematically illustrates code discovery and generation implemented in accordance with one or more aspects of the present disclosure;

FIGS. 3A-3B schematically illustrate an interaction diagram of the test script, the target API, and the generated code implementing the client proxy, the server dispatcher, and the server stub, in accordance with one or more aspects of the present disclosure;

FIG. 4 depicts a flowchart of an example method 400 for automated code generation for facilitating cross-platform software interface, in accordance with one or more aspects of the present disclosure;

FIG. 5 depicts a block diagram of an illustrative computing device operating in accordance with one or more aspects of the present disclosure.

### DETAILED DESCRIPTION

Described herein are systems and methods for automated code generation to facilitate cross-platform software interfaces. Such methods and systems may be employed, for example, for functional testing of interactive video game applications and/or other client/server applications.

In an illustrative example, a static or dynamically loadable library implementing a video gaming platform on a video gaming server may expose an API invocable by one or more remote gaming clients. In another illustrative example, a static or dynamically loadable library implementing a video gaming platform may reside on a personal computer, mobile computing device (e.g., a smartphone), or an interactive video gaming console, and may expose an API invocable by local interactive video gaming applications.

Functional testing of the API exposed by a static or dynamically loadable library may involve executing, by a remote or a local testing client, a test script describing a sequence of API calls to the static or dynamically loadable library and specify values of the API call parameters. Since, as noted herein above, the API under test may be implemented on a variety of hardware and software platforms, the test script should be able to adapt to the variety of platforms, which would manifest itself, e.g., in a variety of ways in which the API call parameters should be encoded or otherwise represented.

The present disclosure implements a platform-agnostic software interface between the testing client and applications under test. In an illustrative example, the interface may be implemented by automatically generated client proxy, server dispatcher, and server stub, as described in more detail herein below. Advantages of the software interface described herein over various common solutions include: support for any target platform (e.g., a personal computing device, a mobile communication device, or an interactive video gaming console), support of target APIs implementing any parameter passing or naming conventions, and support for pointers and/or file handles as the API call parameters and/or return values.

Various aspects of the above referenced methods and systems are described in details herein below by way of examples, rather than by way of limitation.

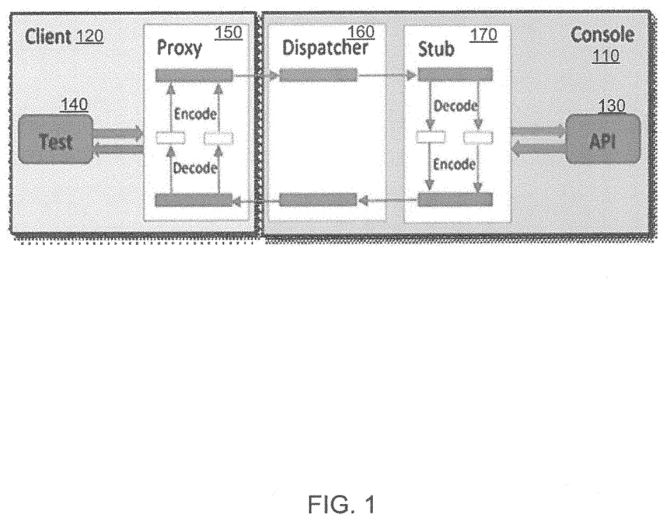

FIG. 1 schematically illustrates a high-level component diagram of a distributed computer system operating in accordance with one or more aspects of the present disclosure. As shown in FIG. 1, the distributed computer system 100 may include the target platform 110 and the testing client 120. In various illustrative examples, the target platform 110 may be represented by a personal computer, a mobile communication device (such as a smartphone), a video gaming console, or a video gaming server. The target platform 110 may execute various software applications, including a static or dynamically loadable library that implements the API 130 which undergoes functional testing.

The testing client 120 may, in certain implementations, run on a dedicated computer system and may access one or more target platforms 110 via a network. Alternatively, the testing client 120 may run locally on the target platform 110. The testing client may execute a testing script 140 describing a sequence of calls to the API 130. For each API call, the testing script may specify the parameter values and the expected return value, and may further specify how to process errors which may be returned by the API call (e.g., logging the error, displaying a notification, branching the script execution based on the return value, etc.).

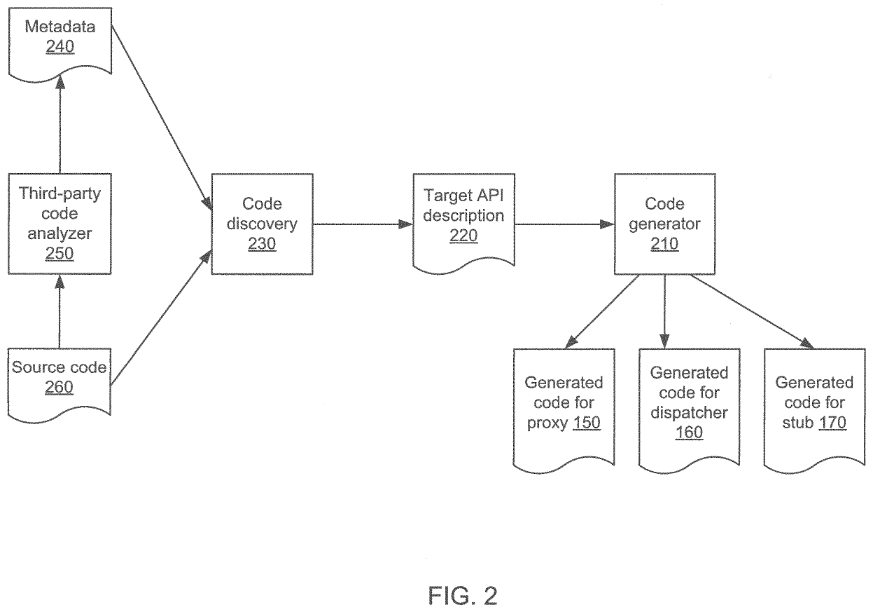

A software interface between the testing script 140 and the API 130 is implemented by the client proxy 150, server dispatcher 160, and server stub 170. As schematically illustrated by FIG. 2, the interface modules 150, 160, and 170 may be automatically generated by a code generator 210 based on a definition 220 of the target API 130. The definition 220 of API 130, including method names, parameters, and return values, may be automatically generated by a code discovery module 230.

In an illustrative example, the code discovery module 230 may receive and process metadata 240 produced by a third-party code analyzer 250 (such as an interactive development environment (IDE)) which would parse the source code 260 implementing the target API 130. The code discovery module 230 may parse the metadata and decode certain fields of interest, thus producing the target API definition 220, which may, for each method of the target API 130, specify the method name, the return value type, as well as names and types of one or more parameters of the method.

In another illustrative example, the code discovery module may implement a code parser to process the source code 260 (e.g., header files) implementing the target API 130. The code parser may scan the header files and extract, for each method of the target API 130, the method name, the return value type, as well as names and types of one or more parameters of the method.

As noted herein above, the code generator 210 may process the definition 220 of the target API 130 and generate the client proxy 150, the server dispatcher 160, and server stub 170. Code generation may utilize various templates, which may specify the prologue, epilogue, and other fragments of the code which are not dependent upon the method names and parameters. Code generation may further implement various rule sets describing the logic of each of the components being generated. The generated source code in a high-level programming language (such as C or C++) may then be compiled and executed in conjunction with execution of the test script 140. In certain implementations, the code generator 210 may be integrated with a third party IDE and may be invoked by the IDE every time when a new target API method is created or a signature of one of the target API methods is updated.

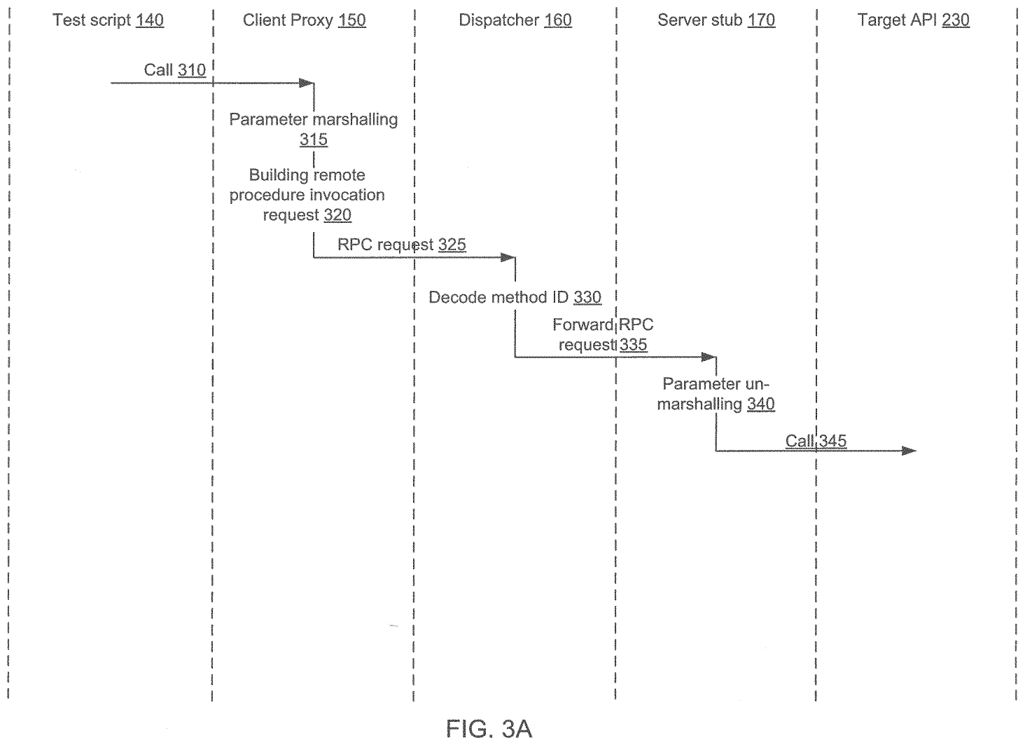

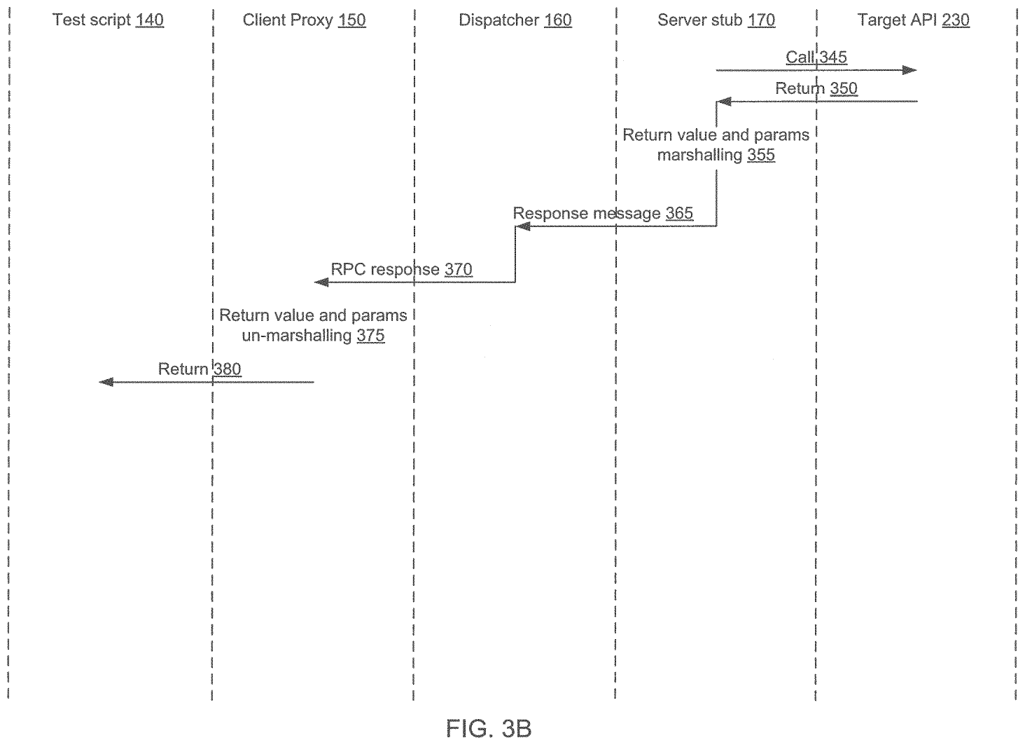

FIGS. 3A-3B schematically illustrate an interaction diagram of the test script 140, the target API 230, and the generated code implementing the client proxy 150, the server dispatcher 160, and the server stub 170, in accordance with one or more aspects of the present disclosure. For each method of the target API 130, the client proxy 150 may include a corresponding proxy code section which is locally invocable by a process running on the client 120 (e.g., by the testing script 140). The proxy code section may implement a method having the same signature (i.e., name and parameter types) as the corresponding method of the target API 130.

Referring to FIG. 3A, the client proxy 150, upon being invoked (310) by the test script 140, may perform parameter marshalling 315 (i.e., encoding the parameter values according to a specified format (e.g., JSON) and packing the encoded parameter values into the payload of a remote procedure invocation request, which is formatted according to a pre-defined remote procedure invocation protocol, such as Remote Procedure Call (RPC)). The client proxy 150 may further build (320) and transmit the remote procedure invocation request 325 to the dispatcher 160 residing on the target server 110.

Parameter marshalling may be performed based on the parameter type. For basic parameter types (such as character, integer, double, etc.), which are passed by value, parameter marshalling may involve encoding and/or formatting the parameter value according to the encoding scheme specified by the relevant protocol (e.g., RPC) and packing the encoded/formatted parameter values into the payload of the remote procedure invocation request 325. For other parameter types (arrays, structures, custom types, etc.), which are passed by reference, as well as for pointers (except for file and socket handles), parameter marshalling may involve copying the byte stream from the client memory buffer specified by the pointer into the payload of the remote procedure invocation request. For file and socket handles, which represent a special type of pointers, parameter marshalling may involve encoding and packing into the payload the pointer value itself (rather than encoding and packing into the payload the byte stream from the memory buffer specified by the pointer), since a handle of a file or a socket opened by the server would not be usable within the address space of the client.

The client proxy 150 may further encode, into the payload of the remote procedure invocation request, an identifier of the method to be invoked, which corresponds to the method which is invoked by the incoming API call 310. The client proxy 150 may transmit the remote procedure invocation request 325 to the server dispatcher 160. In an illustrative example, each method may be assigned a unique identifier (e.g., represented by an integer value). Mappings of the API method names to corresponding unique identifiers may be stored in a suitable memory data structure (e.g., a hash-table) which would allow efficient retrieval of the identifier value corresponding to any given method name, while the reverse mappings may be stored in an array of strings.

In certain implementations, the client's thread transmitting the remote procedure invocation request 325 may be blocked and wait until a corresponding remote procedure invocation response message is received from the server, unless an asynchronous type of the request is specified by the client, in which case there is no blocking of the client thread that has transmitted the remote procedure invocation request.

Responsive to receiving the remote procedure invocation request 325, the server dispatcher 160 may extract (330) the encoded method identifier and invoke (335) a server stub 170 corresponding to the target API method being invoked. The server stub 170 may perform parameter un-marshaling (340) and invoke (345) the desired method of the target API 130. Parameter un-marshalling may be performed based on the parameter type. For basic parameter types (such as character, integer, double, etc.), which are passed by value, parameter un-marshalling may involve decoding the payload field specifying the parameter value and translating, according to the target platform format, the decoded parameter value into a locally stored value to be passed to the target API 130 (e.g., by pushing the value on the local stack of the server stub 170). For other parameter types (arrays, structures, custom types, etc.), which are passed by reference, as well as for pointers (except for file and socket handles), parameter un-marshalling may involve allocating a memory buffer in the memory of the server 110, copying the byte stream from the payload field specifying the parameter value into the memory buffer, a pointer to which is passed to the target API 130 (e.g., by pushing the pointer on the local stack of the server stub 170). The memory buffer will be de-allocated upon the API call return. For file and socket handles, parameter un-marshalling may involve decoding the payload field specifying the parameter value and utilizing the decoded value as the value of the handle to be passed to the target API 130 (e.g., by pushing the value on the local stack of the server stub 170). Upon completing parameter un-marshalling for all parameters, the server stub 170 may invoke (345) the corresponding method of the target API 130.

Referring now to FIG. 3B, upon the API call return (350), the server stub 170 may perform marshaling 355 of the return parameters which have been passed by reference (except for file and socket handles), encode the return value of the method, and build a remote procedure invocation response 365. Marshalling of the passed by reference parameters may involve copying the byte stream from the memory buffer specified by the pointer into the payload of the remote procedure invocation response and de-allocating the previously allocated memory buffer specified by the pointer.

For basic return value types (such as character, integer, double, etc.), which are passed by value, the server stub 170 may copy the return value into the payload of the remote procedure invocation response. For other return value types (arrays, structures, custom types, etc.), which are passed by reference, as well as for pointers (except for file and socket handles), the server stub 170 may copy the contents of the memory buffer specified by the returned pointer into the payload of the remote procedure invocation response.

The server stub may then transmit the complete remote procedure invocation response 365 to the dispatcher 160, which may forward (370) the remote procedure invocation response back to the requesting client 120.

Responsive to receiving the remote procedure invocation response, the client proxy 150 may perform un-marshaling (375) of the passed by reference parameters (except for file and socket handles), encode the return value of the method, and return (380) the execution control to the caller (e.g., the testing script 140).

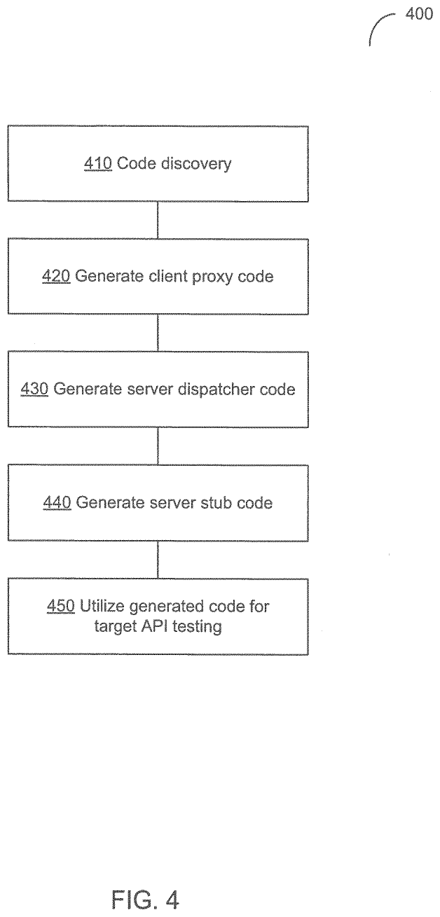

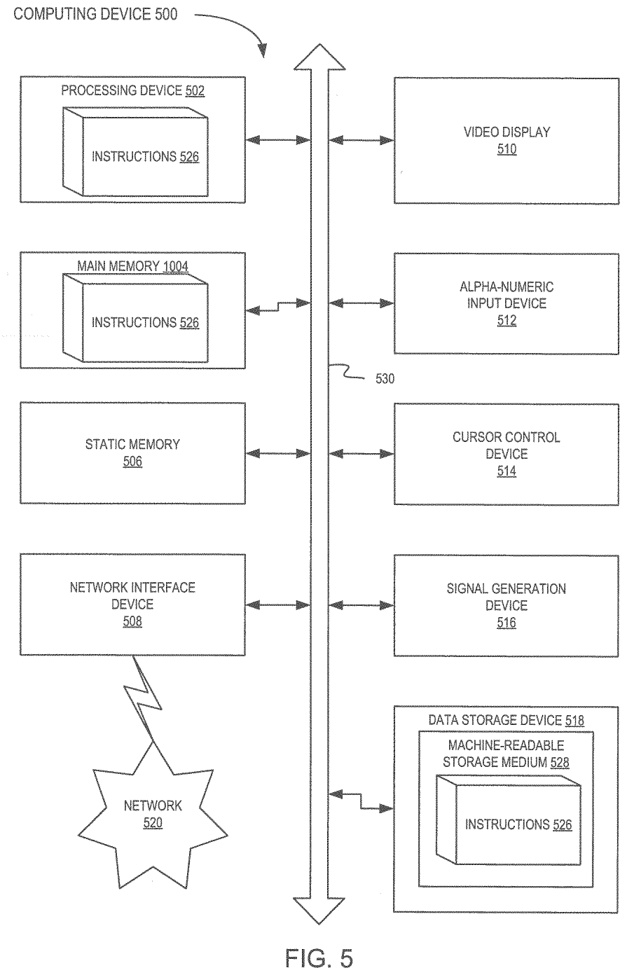

FIG. 4 depicts a flowchart of an example method 400 for automated code generation for facilitating cross-platform software interface, in accordance with one or more aspects of the present disclosure. Method 400 and/or each of its individual functions, routines, subroutines, or operations may be performed by one or more processors of the computer system (e.g., example computer system 500 of FIG. 5) executing the method. In certain implementations, method 400 may be performed by a single processing thread. Alternatively, method 400 may be performed by two or more processing threads, each thread executing one or more individual functions, routines, subroutines, or operations of the method. In an illustrative example, the processing threads implementing method 400 may be synchronized (e.g., using semaphores, critical sections, and/or other thread synchronization mechanisms). Alternatively, the processing threads implementing method 400 may be executed asynchronously with respect to each other. Therefore, while FIG. 4 and the associated description lists the operations of method 400 in certain order, various implementations of the method may perform at least some of the described operations in parallel and/or in arbitrary selected orders.

At block 410, a computer system implementing the method may receive and process metadata produced by a third-party code analyzer (such as an interactive development environment (IDE)) based on parsing the source code implementing the API exposed by the target executable code. The code discovery module produces the target API definition, which may, for each method of the target API, specify the method name, the return value type, as well as names and types of one or more parameters of the method, as described in more detail herein above.

At block 420, the computer system may generate code implementing a client proxy, which performs parameter marshalling (i.e., encoding the parameter values according to a specified format and packing the encoded parameter values into the payload of a remote procedure invocation request formatted according to a pre-defined remote procedure invocation protocol, such as Remote Procedure Call (RPC)). The client proxy transmits the remote procedure invocation request to the server dispatcher residing on the target server. Responsive to receiving a remote procedure invocation response corresponding to the remote procedure invocation request, the client proxy performs un-marshaling of the return parameters, encodes the return value of the method, and returns the execution control to the caller, as described in more detail herein above.

At block 430, the computer system may generate code implementing a server dispatcher, which receives the remote procedure invocation request, decodes a method identifier encoded by the remote procedure invocation request, and forwards the remote procedure invocation request to a server stub identified by the method identifier, as described in more detail herein above.

At block 440, the computer system may generate code implementing the server stub, which translates the remote procedure invocation request into a call to the API exposed by the target executable code. Upon the API call return, the server stub performs marshaling of the return parameters, encodes the return value of the method, and builds a remote procedure invocation response. The server stub then transmits the remote procedure invocation response to the server dispatcher, which in turn forwards the remote procedure invocation response back to the requesting client, as described in more detail herein above.

At block 450, the computer system may utilize the generated code for testing the target API, e.g., by executing a test script describing a sequence of API calls to the target API, and the method may terminate.

While the above description includes illustrative examples of utilizing the generated code for API testing, the generated code may be utilized for facilitating cross-platform software interface in various other applications. Furthermore, while the above description includes illustrative examples of utilizing RPC protocol for the client-server communications, various other suitable protocols may be utilized for facilitating the remote procedure invocations by the systems and methods of the present disclosure.

FIG. 5 illustrates a diagrammatic representation of a computing device 500 which may implement the systems and methods described herein. Computing device 500 may be connected to other computing devices in a LAN, an intranet, an extranet, and/or the Internet. The computing device may operate in the capacity of a server machine in client-server network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 500 may include a processing device (e.g., a general purpose processor) 502, a main memory 504 (e.g., synchronous dynamic random access memory (DRAM), read-only memory (ROM)), a static memory 506 (e.g., flash memory and a data storage device 518), which may communicate with each other via a bus 530.

Processing device 502 may be provided by one or more general-purpose processing devices such as a microprocessor, central processing unit, or the like. In an illustrative example, processing device 502 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 502 may also comprise one or more special-purpose processing devices such as an application specific integrated circuit (ASIC), a field programmable gate array (FPGA), a digital signal processor (DSP), network processor, or the like. The processing device 502 may be configured to execute module 526 implementing method 400 for automated code generation for facilitating cross-platform software interface, in accordance with one or more aspects of the present disclosure, for performing the operations and steps discussed herein.

Computing device 500 may further include a network interface device 508 which may communicate with a network 520. The computing device 500 also may include a video display unit 55 (e.g., a liquid crystal display (LCD) or a cathode ray tube (CRT)), an alphanumeric input device 512 (e.g., a keyboard), a cursor control device 514 (e.g., a mouse) and an acoustic signal generation device 516 (e.g., a speaker). In one embodiment, video display unit 55, alphanumeric input device 512, and cursor control device 514 may be combined into a single component or device (e.g., an LCD touch screen).

Data storage device 518 may include a computer-readable storage medium 528 on which may be stored one or more sets of instructions, e.g., instructions of module 526 implementing method 400 for automated code generation for facilitating cross-platform software interface. Instructions implementing module 526 may also reside, completely or at least partially, within main memory 504 and/or within processing device 502 during execution thereof by computing device 500, main memory 504 and processing device 502 also constituting computer-readable media. The instructions may further be transmitted or received over a network 520 via network interface device 508.

While computer-readable storage medium 528 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “updating”, “identifying”, “determining”, “sending”, “assigning”, or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc. as used herein are meant as labels to distinguish among different elements and may not necessarily have an ordinal meaning according to their numerical designation.

Examples described herein also relate to an apparatus for performing the methods described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

What is claimed is:

1. A method, comprising:
receiving, by a computer system, a definition of an application programming interface (API) exposed by a target executable code running on a server;
generating a first code implementing a client proxy for translating an incoming API call to a remote procedure invocation request;
generating a second code implementing a server dispatcher for receiving the remote procedure invocation request, decoding a method identifier encoded by the remote procedure invocation request, and forwarding the remote procedure invocation request to a server stub identified by the method identifier; and
generating a third code implementing the server stub for translating the remote procedure invocation request into a call to the API exposed by the target executable code.

2. The method of claim 1, further comprising:
utilizing the first code, the second code, and the third code for performing functional testing of the target executable code.

3. The method of claim 1, further comprising:
generating the definition of the API by analyzing a source code file corresponding to the target executable code.

4. The method of claim 1, further comprising:
generating the definition of the API by analyzing metadata derived from a source code file corresponding to the target executable code.

5. The method of claim 1, wherein generating the first code implementing the client proxy further comprises:
generating code for marshalling of a parameter of the incoming API call.

6. The method of claim 1, wherein generating the first code implementing the client proxy further comprises:
generating code for building a remote procedure invocation request corresponding to the incoming API call.

7. The method of claim 1, wherein generating the first code implementing the client proxy further comprises:
generating code for un-marshalling of a remote procedure invocation response corresponding to the remote procedure invocation request.

8. The method of claim 1, wherein generating the second code implementing the server dispatcher further comprises:
generating code for decoding an identifier of a method invoked by the remote procedure invocation request and forwarding the remote procedure invocation request to a server stub identified by the identifier of the method.

9. The method of claim 1, wherein generating the third code implementing the server stub further comprises:
generating code for un-marshalling the parameter encoded by the remote procedure invocation request and invoking the API exposed by the target executable code.

10. The method of claim 1, wherein generating the third code implementing the server stub further comprises:
generating code for allocating a memory buffer for storing a value of a parameter of the incoming API call, wherein the parameter is identified by a pointer.

11. The method of claim 10, wherein generating the third code implementing the server stub further comprises:
generating code for copying the value of the parameter from the memory buffer into a remote procedure invocation response and de-allocating the memory buffer responsive to receiving a return from the API exposed by the target executable code.

12. A system, comprising:
a memory;
a processor, coupled to the memory, the processor configured to:
receive a definition of an application programming interface (API) exposed by a target executable code running on a server;
generate a first code implementing a client proxy for translating an incoming API call to a remote procedure invocation request; and
generate a second code implementing a server dispatcher for receiving the remote procedure invocation request, decoding a method identifier encoded by the remote procedure invocation request, and forwarding the remote procedure invocation request to a server stub identified by the method identifier;
generate a third code implementing the server stub for translating the remote procedure invocation request into a call to the API exposed by the target executable code.

13. The system of claim 12, wherein the processor is further configured to:
utilize the first code, the second code, and the third code for performing functional testing of the target executable code.

14. The system of claim 12, wherein the processor is further configured to:
generate the definition of the API by analyzing metadata derived from a source code file corresponding to the target executable code.

15. The system of claim 12, wherein generating the first code implementing the client proxy further comprises:
generating code for marshalling of a parameter of the incoming API call.

16. The system of claim 12, wherein generating the third code implementing the server stub further comprises:
generating code for un-marshalling the parameter encoded by the remote procedure invocation request and invoking the API exposed by the target executable code.

17. A computer-readable non-transitory storage medium comprising executable instructions that, when executed by a computer system, cause the computer system to:
receive a definition of an application programming interface (API) exposed by a target executable code running on a server;
generate a first code implementing a client proxy for translating an incoming API call to a remote procedure invocation request; and
generate a second code implementing a server dispatcher for receiving the remote procedure invocation request, decoding a method identifier encoded by the remote procedure invocation request, and forwarding the remote procedure invocation request to a server stub identified by the method identifier;
generate a third code implementing the server stub for translating the remote procedure invocation request into a call to the API exposed by the target executable code.

18. The computer-readable non-transitory storage medium of claim 17, further comprising executable instructions causing the computer system to:
utilize the first code, the second code, and the third code for performing functional testing of the target executable code.

19. The computer-readable non-transitory storage medium of claim 17, further comprising executable instructions causing the computer system to:
generate the definition of the API by analyzing metadata derived from a source code file corresponding to the target executable code.

20. The computer-readable non-transitory storage medium of claim 17, wherein generating the first code implementing the client proxy further comprises:
generating code for marshalling of a parameter of the incoming API call.
